(19) United States
(12) Patent Application Publication
(10) Pub. No.: US 2023/0224679 A1
(43) Pub. Date: Jul. 13, 2023

(54) HANDOVER SCHEMES IN MULTICAST BROADCAST SERVICES

(71) Applicant: ZTE Corporation, Shenzhen (CN)

(72) Inventors: Xueying DIAO, Shenzhen (CN); Lin CHEN, Shenzhen (CN); Tao QI, Shenzhen (CN)

(73) Assignee: ZTE Corporation, Shenzhen (CN)

(21) Appl. No.: 18/113,822

(22) Filed: Feb. 24, 2023

Related U.S. Application Data
(63) Continuation of application No. PCT/CN2020/122714, filed on Oct. 22, 2020.

(51) Int. Cl. H04W 4/06; H04W 76/20

(52) U.S. Cl. CPC H04W 4/06; H04W 76/20

(57) ABSTRACT

A method of wireless communication is described. The method includes receiving, by a first communication node from a second communication node, a first message that includes multicast broadcast service (MBS) information related to one or more multicast broadcast service (MBS) sessions; and sending, by the first communication node, to the second communication node, a second message that includes information for the one or more MBS sessions

### TECHNICAL FIELD

This patent document generally relates to systems, devices, and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices.

### SUMMARY

This document relates to methods, systems, and devices for measurement configuration and reporting schemes in wireless communications.

In one aspect, a wireless communication method is disclosed. The wireless communication method includes receiving, by a first communication node from a second communication node, a first message that includes multicast broadcast service (MBS) information related to one or more multicast broadcast service (MBS) sessions; and sending, by the first communication node, to the second communication node, a second message that information for the one or more MBS sessions.

In another aspect, a wireless communication method is disclosed. The wireless communication method includes sending, by the first communication node to a second communication node, a first message that includes multicast broadcast service (MBS) information related to one or more multicast broadcast service (MBS) sessions; and receiving, by the first communication node, from the second communication node, a second message that includes information for the one or more MBS sessions.

In another aspect, a wireless communication apparatus comprising a processor configured to perform the disclosed methods is disclosed.

In another aspect, a computer readable medium having code stored thereon is disclosed. The code, when implemented by a processor, causes the processor to implement a. method described in the present document.

These, and other features, are described in the present document.

### BRIEF DESCRIPTION OF THE DRAWING

FIG. 1 shows a flowchart explaining a handover procedure based on some implementations of the disclosed technology.

FIG. 2 shows a flowchart explaining a handover procedure based on some implementations of the disclosed technology,

FIG. 3 shows a flowchart explaining a handover procedure based on some implementations of the disclosed technology.

FIG. 4 shows an example of a configuration showing PTM initial transmission and PTP retransmission.

FIG. 5A shows an example of a method for wireless communication based on some implementations of the disclosed technology.

FIG. 5B shows an example of a method for wireless communication based on some implementations of the disclosed technology.

FIG. 6 shows an example of wireless communication including a base station (BS) and user equipment (UE) based on some implementations of the disclosed technology.

FIG. 7 shows an example of a block diagram of a portion of an apparatus based on sonic implementations of the disclosed technology.

### DETAILED DESCRIPTION

The disclosed technology provides implementations and examples of handover schemes in multicast broadcast services (MBS) networks. With the continuous development of 5G (5th generation mobile networks), 5G solutions for various application scenarios are accelerating the integration. At present, 5G base stations support CU/DU separation and CU CP/UP separation. The multicast broadcast service scenario is a traditional service scenario that exists to meet the needs of most users for the same service. At present, the 5G-related technologies that have been discussed and standardized in the industry are mainly about unicast business scenarios. With the rapid growth of the number of users and the multi-dimensional application scenarios, the point-to-multipoint business model will inevitably become one of the indispensable service models. Some implementations of the disclosed technology relate to how to reasonably and effectively realize the multicast broadcasting service under the technical framework of 5G-NR (New Radio, New Radio).

From the view point of 5G CN, following two delivery methods are available:

(1) 5GC Individual MBS traffic delivery method: 5G CN receives a single copy of MBS data packets and delivers separate copies of those MBS data packets to individual UEs via per-UE PDU sessions.

(2) 5GC Shared MBS traffic delivery method: 5G CN receives a single copy of MBS data packets and delivers a single copy of those MBS packets packet to a RAN node, which then delivers them to one or multiple UEs.

The tunnel established between 5GC and NG-RAN in the Individual MBS traffic delivery method can be named individual tunnel. Similarly, the tunnel established between 5GC and NG-RAN in the Shared MBS traffic delivery method can be called shared tunnel. Considering that the user equipment (UE) may move across different base stations, the handover procedure in the MBS scenario, which involves the tunnel mode switch process, needs to be considered.

Hereinafter, the detailed configuration and signaling for various implementations of the disclosed technology are described. Section headings are used in the present document only to facilitate ease of understanding and scope of the embodiments and techniques described in each section are not only limited to that section. Furthermore, while 5G terminology is used in sonic cases to facilitate understanding of the disclosed techniques, which may be applied to wireless systems and devices that use communication protocols other than 5G or 3GPP protocols.

### Implementation 1

In this implementations, the source gNB supports shared tunnel, and the target gNB is MBS capable (target gNB supports MBS). Since the target gNB is MBS capable, the gNB can support the shared tunnel mode. In this embodiment, the 5GC establishes or modifies MB session resources in the course of handover preparation phase, prior to handover execution phase.

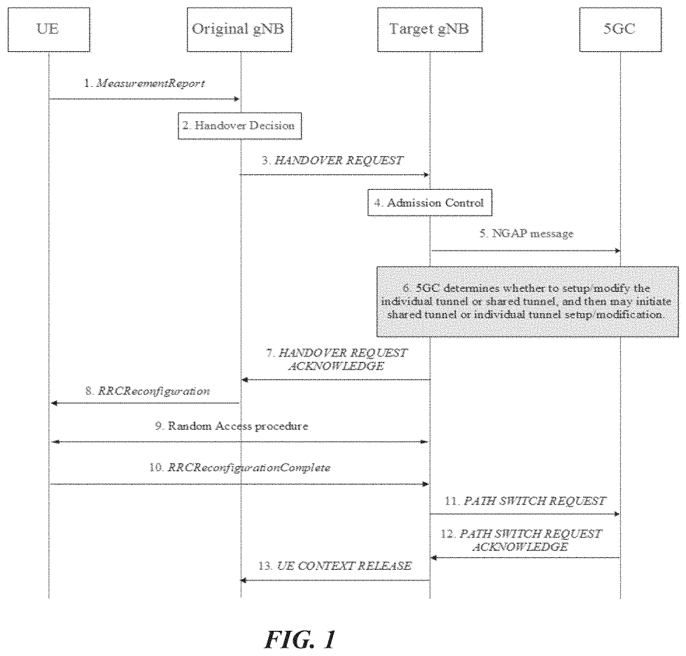

FIG. 1 shows a flowchart explaining a handover procedure based on some implementations of the disclosed technology. As shown in FIG. 1, the handover procedure includes following steps:

Step 1: UE sends a MeasurementReport message to the source gNB. This report is based on a measurement configuration that the UE previously received from the source gNB.

Step 2: The source gNB decides to handover the UE based on the MeasurementReport and RPM (radio resource management) information.

Step 3: The source gNB sends a handover request message to the target gNB. The message may include at least one of MBS (multicast-broadcast services) session ID, temporary mobile group identity (TMGI), MBS service ID, MBS session aggregate maximum bit rate (AMBR), MBS session type, MBS quality of service (QoS) flow information, a mode of a point-to-point (PTP) or point-to-multipoint (PTM) scheme used for the UE at the source gNB, and/or multicast IP address. Point-to-Point (PTP) delivery method means a RAN node delivers separate copies of MBS data packet over radio to individual UE. Point-to-Multipoint (PTM) delivery method means a RAN node delivers a single copy of MBS data packets over radio to a set of UEs.

Step 4: The target gNB performs the admission control.

Step 5: The target gNB sends an NG application protocol (NGAP) message to the 5GC (5G core network). The message may include assistance information, e.g. tunnel mode used for the UE at source gNB or the tunnel mode that target gNB prefers to apply for the UE. The message may also include the UE identifier.

Step 6: The 5GC determines whether to setup/modify the individual tunnel or shared tunnel, and then may initiate shared tunnel or individual tunnel setup/modification. If the shared tunnel has already established at the target gNB, and the 5GC determines to use the shared tunnel for the UE. The 5GC may send an indication to the target gNB that the shared tunnel would be used for the UE.

Step 7: The target gNB prepares the handover with L1/L2. The target gNB sends the handover request acknowledge to the source gNB, which may include MBS session resources admitted list. The message may include a transparent container to be sent to the UE as an RRC message to perform the handover. The container includes bearer configuration related to MBS. In some implementations, the target gNB may further provide whether the target gNB supports shared N3 tunnel for the UE's interested MBS sessions, which are being setup or to be setup at the target gNB. In some implementations, the target gNB may provide cell information to the source gNB. In some implementations, the cell information may include information about which cell supports the MBS services that UE is interested in. In some implementations, the cell information may include information about which cell supports PTP and/or PTM transmission of the MBS services that UE is interested in.

Step 8: The source gNB triggers the Uu handover by sending an RRCReconfiguration message to the UE.

Step 9: A random access procedure is performed.

Step 10: The UE responds to the target gNB with an RRCReconfigurationComplete message.

Step 11: The target gNB sends a path switch request message to mobility management function (AMF) to trigger the 5GC to switch the downlink (DL) data path towards the target gNB.

Step 12: The AMF confirms the path switch request message with the path switch request acknowledge message.

Step 13: Upon reception of the path switch request acknowledge message from the AMF, the target gNB sends the UE context release to inform the source gNB about the success of the handover. The source gNB can then release radio and C-plane related resources associated only to the UE. The source gNB may remove the UE ID from the MBS interested member list. The source gNB may release MRBs (multicast radio bearer) if the UE is the last one receiving MBS traffic at the source gNB.

### Implementation 2

In this implementations, the source gNB supports the shared tunnel, and the target gNB is MBS capable. In this embodiment, the AMF may take responsibility for the MB session resource setup/modify in the target NG radio access network (NG-RAN) after the UE was handed over to the target NG-RAN. New message may be introduced. Alternatively, parameters in the path switch request/response messages may provide some optimization. This option would result in a somewhat bigger gap in the MB session continuity.

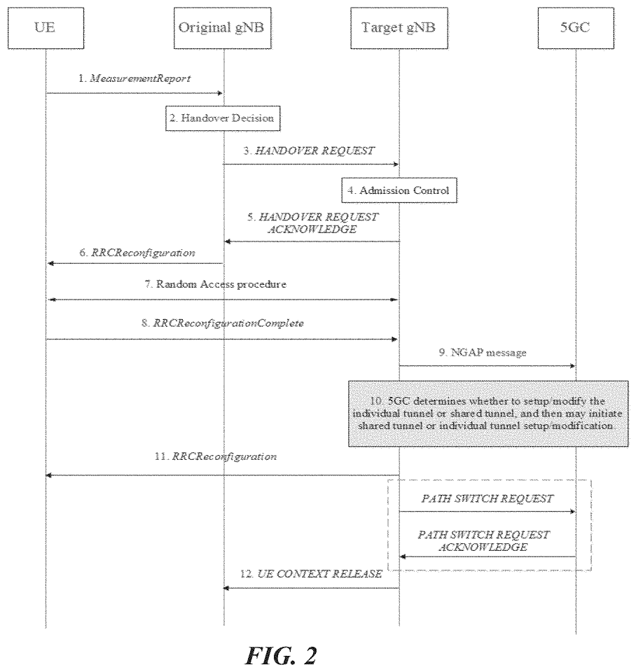

FIG. 2 shows a flowchart explaining a handover procedure based on some implementations of the disclosed technology. As shown in FIG. 2, the handover procedure includes following steps:

Step 1: UE sends a MeasurementReport message to the source gNB. This report is based on a measurement configuration that the UE previously received from the source gNB.

Step 2: The source gNB decides to handover the UE based on the MeasurementReport and RPM information.

Step 3: The source gNB sends a handover request message to the target gNB. The message may include at least one of MBS (multicast-broadcast, services) session ID, TMGI, MBS service ID, MBS session aggregate maximum bit rate (AMBR), MBS session type, MBS quality of service (QoS) flow information, PTP or PTM mode used for the UE at the source gNB, and/or multicast IP address.

Step 4: The target gNB performs the admission control.

Step 5: The target gNB sends the handover request acknowledge to the source gNB, which may include MBS session resources admitted list.

In some implementations, the target gNB may further provide whether the target gNB supports shared N3 tunnel for the UL's interested MBS sessions, which are being setup or to be setup at the target gNB. In some implementations, the target gNB may provide cell information to the source gNB. In some implementations, the cell information may include information about which cell supports the MBS services that UE is interested in. In some implementations, the cell information may include information about which cell supports PTP and/or PTM transmission of the MBS services that UE is interested in.

Step 6: The source gNB triggers the Uu handover by sending an RRCReconfiguration message to the UE.

Step 7: A random access procedure is performed.

Step 8: The UE responds to the target gNB with an RRCReconfigurationComplete message.

Step 9: After the UE access, the target gNB sends an NGAP message to the 5GC. The NEAP message can be a new defined message or a path switch request message. The message may include assistance info, e.g. tunnel mode at source or preferred tunnel mode at target. The message may also include the UE identifier. The target gNB may request 5GC to setup shared/individual tunnel for the UE.

Step 10: The 5GC determines whether to setup/modify the individual tunnel or the shared tunnel, and then may initiate the shared tunnel or the individual tunnel setup/modification. If the shared tunnel has already established at the target gNB, and the 5GC determines to use the shared tunnel for the UE. The 5GC may send an indication to the target gNB that the shared tunnel would be used for the UE. The AMF responses the target gNB with an NGAP message. The NGAP message can be a new defined message or the path switch request acknowledge message.

Step 11: Target gNB prepares the handover with L1/L2. The target gNB sends an RRCReconfiguration message to the UE, which may include bearer configuration related to MBS.

Step 12: Upon reception of the path switch request acknowledge message from the AMF, the target gNB sends the UE context release to inform the source gNB about the success of the handover. The source gNB can then release radio and C-plane related resources associated only to the UE. The source gNB may remove the UE ID from the MBS interested member list. The source gNB may release MRBs (multicast radio bearer) if the UE is the last one receiving MBS traffic at the source gNB.

If the NGAP message used in Step 9 and Step 10 is not the path switch request and the path switch request acknowledgement the existing path switch procedure shall be performed after Step 11, to be specific, the target gNB sends a path switch request message to AMF to trigger the 5GC to switch the DL data path towards the target gNB, and the AMF confirms the path switch request message with the path switch request acknowledge message.

### Implementation 3

In this implementations, source gNB supports shared tunnel, and the target gNB is MBS capable. In this embodiment, UE initiates MB Session resources setup/modification after accessing to the target gNB.

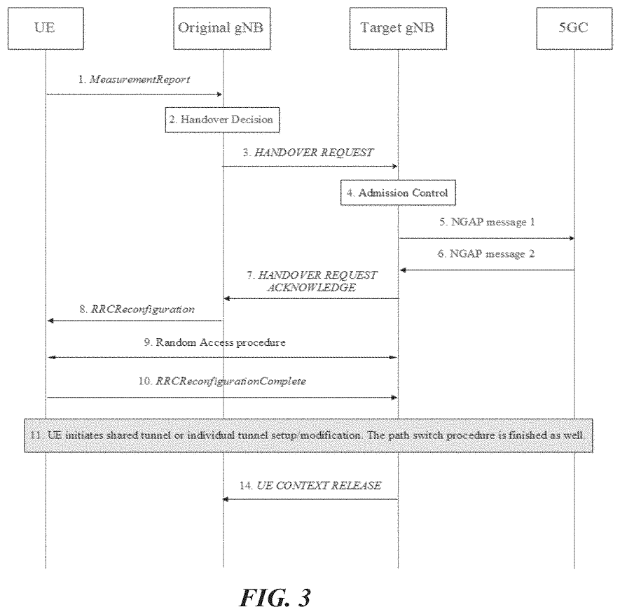

FIG. 3 shows a flowchart explaining a handover procedure based on some implementations of the disclosed technology. As shown in FIG. 3, the handover procedure includes following steps:

Step 1: UE sends a Measurement Report message to the source gNB. This report is based on a measurement configuration that the UE previously received from the source gNB.

Step 2: The source gNB decides to handover the UE based on MeasurementReport and RRM information.

Step 3: The source gNB sends a handover request message to the target gNB. The message may include at least one of MBS (multicast-broadcast services) session ID, TMGI, MBS service ID, MBS session aggregate maximum bit rate (AMBR), MBS session type, MBS quality of service (QoS) flow information, PTP or PTM mode used for the UE at the source gNB, and/or multicast IP address.

Step 4: The target gNB performs the admission control.

Step 5: The target gNB sends a first NGAP message (“NGAP message 1”) to 5GC. The message may include assistance information, e.g. tunnel mode at source or preferred tunnel mode at target. The message may also include the UE identifier.

Step 6: 5GC determines whether to setup/modify the individual tunnel or shared tunnel and responses target gNB with an a second NGAP message (“NGAP message 2”). The message may include an indication to inform the target gNB that the UE initiates the shared tunnel or the individual tunnel setup/modification. Alternatively, the message includes a transparent container to be sent to the UE as an RRC message to initiate the shared tunnel or the individual tunnel setup/modification.

Step 7: The target gNB sends the handover request acknowledge to the source gNB. The message may include an indication to inform the source gNB that the UE initiates shared tunnel or individual tunnel setup/modification. Alternatively, the message includes a transparent container to be sent to the UE as an RRC message to initiate shared tunnel or individual tunnel setup/modification.

Step 8: The source gNB triggers the Uu handover by sending an RRCReconfiguration message to the UE. The message may include an indication to inform the UE to initiate the shared tunnel or the individual tunnel setup/modification. Alternatively, the message includes a container used to request the UE to initiate the shared tunnel or the individual tunnel setup/modification.

Step 9: A random access procedure is performed.

Step 10: The UE responds to the target gNB with an RRCReconfigurationComplete message.

Step 11: The UE initiates the shared tunnel or the individual tunnel setup/modification. The path switch procedure is finished as well.

Step 12: Upon reception of the path switch request acknowledge message from the AMF, the target gNB sends the UE context release to inform the source gNB about the success of the handover: The source gNB can then release radio and C-plane related resources associated only to the UE. The source gNB may remove the UE ID from the MBS interested member list. The source gNB may release MRBs (multicast radio bearer) if the UE is the last one receiving MBS traffic at the source gNB.

### Implementation 4

In this implementations, the source gNB supports the shared tunnel, and the target gNB is non-MBS capable (target gNB does not support MBS). The target gNB does not support shared tunnel mode. In this implementation, source gNB initiates NG based handover procedure.

In this implementation, the handover procedure includes following steps:

Step 1: The UE sends a MeasurementReport message to the source gNB. This report is based on a measurement configuration that the UE previously received from the source gNB.

Step 2: The source gNB decides to handover the UE based on MeasurementReport and RRM information.

Step 3: The source gNB sends a handover request message to 5GC.

Step 4: Based on the handover request message that includes the UE identifier and target gNB identifier, the 5GC recognizes the target gNB is non-MBS capable. The 5GC initiates the individual tunnel setup at the target gNB. In addition, the handover request message is sent to the target gNB.

Step 5: The target gNB sends the handover request acknowledge message to 5GC.

The remaining procedure is the same as the existing Inter NG-RAN node N2 based handover procedure.

### Implementation 5

In this implementations, the source gNB supports shared tunnel, and the target gNB is non-MBS capable and thus does not support the shared tunnel mode. Since the target gNB is MBS capable, the gNB can support the shared tunnel mode.

In this embodiment, tunnel mode is changed before UE accesses to the target gNB. The tunnel mode is changed from shared tunnel to individual tunnel.

Step 1: UE sends a MeasurementReport message to the source gNB. This report is based on a measurement configuration that the UE previously received from the source gNB.

Step 2: The source gNB decides to handover the UE based on MeasurementReport and RRM information.

Step 3: The source gNB sends a handover request message to the target gNB. The message includes unicast PDU Session information. To be specific, the unicast PDU Session information includes the information of the QoS flows of the unicast PDU session associated with the MBS session.

Step 4: The target gNB performs the admission control.

Step 5: The target gNB sends the handover request acknowledge to the source gNB.

Step 6: The source gNB sends an NGAP message to the 5GC. The message may include a UE identifier. In some implementation, the NGAP message may further include a target gNB identifier. In some implementations, the NGAP message may further include a. mode switch indication. In some implementations, the NGAP message may further include an individual tunnel setup request indication. In some implementations, the NGAP message may further include unicast PDU Session information received in the PDU session resources admitted list in the handover request acknowledge message.

Step 7: The individual tunnel setup is initiated for the UE. The source gNB sends an RRCReconfiguration message to the UE.

Step 8: A random access procedure is performed.

Step 9: The target gNB sends a path switch request message to AMF to trigger 5GC to switch the DL data path towards the target gNB.

Step 10: The AMF confirms the path switch request message with the path switch request acknowledge message.

Step 11: Upon reception of the path switch request acknowledge message from the AMF, the target gNB sends the UE, context release to inform the source gNB about the success of the handover. The source gNB can then release radio and C-plane related resources associated only to the UE. The source gNB may remove the UE ID from the MBS interested member list. The source gNB may release MRBs (multicast radio bearer) if the UE is the last one receiving MBS traffic at the source gNB.

### Implementation 6

In this implementations, the source gNB supports the shared tunnel, and the target gNB is non-MBS capable and thus does not support the shared tunnel mode. In this implementation, the source gNB changes the tunnel mode for the UE before sending the handover request message to the target gNB. The tunnel mode is changed from the shared tunnel to the individual tunnel.

After receiving the MeasurementReport message from UE, the source gNB finds that the target gNB is non-MBS capable. The source gNB sends an NGAP message to 5GC. The NGAP message may include an UE identifier. In some implementations, the NGAP message may further include a target gNB identifier, In some implementations, the NGAP message may further include a mode switch indication. In some implementations, the NGAP message may further include an individual tunnel setup request indication. Then, the individual tunnel setup is initiated for the UE. After the individual tunnel is setup, the source gNB performs the existing intra-NR RAN handover procedure with the target gNB.

### Implementation 7

The source gNB can send the handover request message to several candidate gNBs, The message may further include MBS interested indication of the UE. If the source gNB has received the correlation between a MBS session information and a PDU session information from 5GC, the message may further include the PDU session information which is mapped from the MBS session information. The PDU session information may include the PDU session ID corresponding to the MBS session ID/TMGI/MBS service ID, the PDU session QoS flow parameters (called unicast PDU session mapped QoS flow parameters) corresponding to MBS QoS flow parameters.

If the source gNB receives the handover request acknowledge message from several candidates, the source gNB selects the most suitable one as the target gNB. The source gNB can further select the most suitable cell among the candidate cells provided by candidate gNBs. How to select the most suitable gNB or cell can be varied based on implementations. The source gNB can optionally send an indication to the target gNB to inform that it is chosen. The source gNB can optionally send the selected cell identity to the target gNB.

### Implementation 8

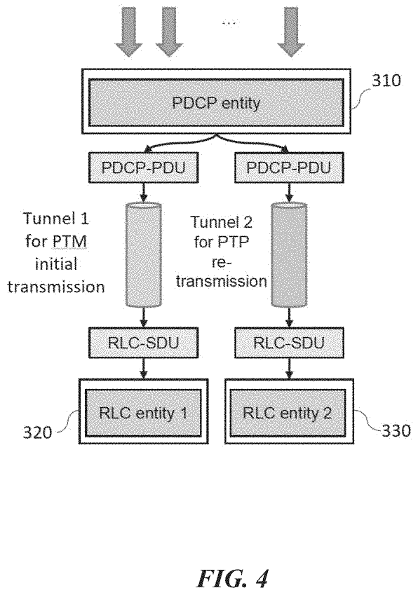

If the gNB (the source gNB and/or the target GNB) uses shared tunnel for MBS service(s), there may be one tunnel used for DL MBS traffic initial transmission. The additional tunnel(s) may be established for each UE for DL (downlink) MBS traffic re-transmission. FIG. 4 shows an example of PTM transmissions. In this case, the same PDCP PDU is only sent once to DU, duplicated and submitted to the corresponding RLC entities at a DU side for specific delivery instances. One PDCP entity 310 is associated with several RLC entities (e.g., RLC entity 1 320, RLC entity 2 330 in FIG. 4). Each of the RLC entities 320 and 330 may be used for PTP mode or PTM, mode. Thus, these RLC entities may have different type of the RLC mode, e.g. RLC-TM, RLC-AM, RLC-UM-Bidirectional, RLC-UM-Unidirectional-UL, RLC-UM-Unidirectional-DL and so on. During MRB setup/modification procedure, the CU control plane (CU-CP) of the gNB may send the RLC mode associated with each tunnel to the CU user plane (CU-UP) of the gNB. The tunnel can be used for DL MBS traffic initial transmission or DL MBS traffic re-transmission. CU-CP may send the RLC mode associated to each tunnel to DU as well.

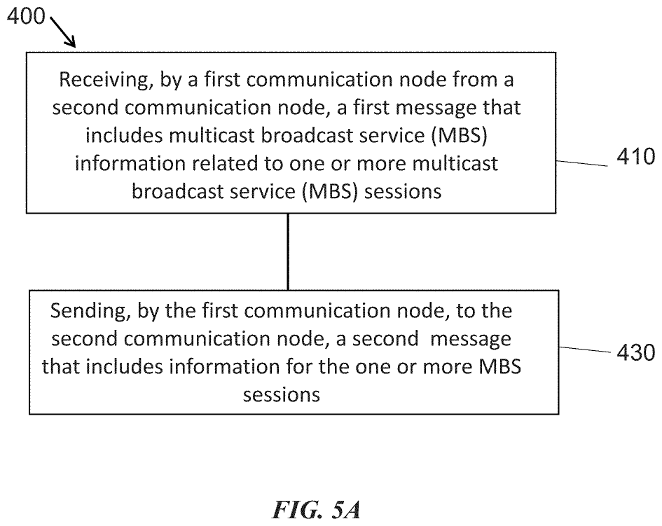

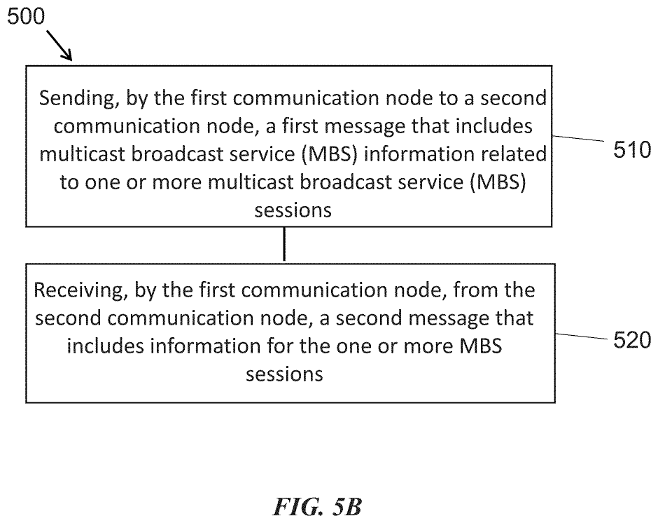

The implementations and examples of the wireless communication method disclosed above can facilitate handover procedures in multicast broadcast services. FIG. 5A shows an example of a wireless communication method. The method 400 includes, at the operation 410, receiving, by a first communication node from a second communication node, a first message that includes multicast broadcast service (MBS) information related to one or more multicast broadcast service (MBS) sessions. The method 400 further includes, at the operation 430, sending, by the first communication node, to the second communication node, a second message that includes information for the one or more MBS sessions.

FIG. 5B shows another example of a wireless communication method. The method 500 includes, at the operation 510, sending, by the first communication node to a second communication node, a first message that includes multicast broadcast service (MBS) information related to one or more multicast broadcast service (MBS) sessions. The method 510 further includes, at the operation 520, receiving, by the first communication node, from the second communication node, a second message that includes information for the one or more MBS sessions.

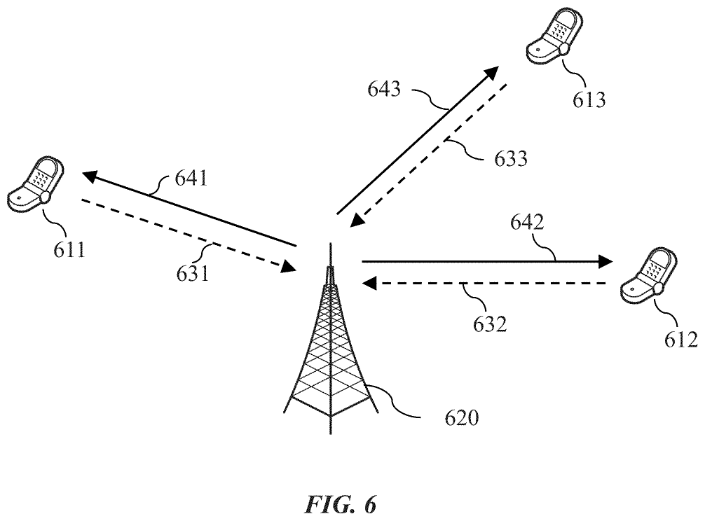

The implementations as discussed above will apply to a wireless communication. FIG. 6 shows an example of a wireless communication system (e.g., a 5G or NR cellular network) that includes a BS 620 and one or more user equipment (UE) 611, 612 and 613. In some embodiments, the UEs access the BS (e.g., the network) using implementations of the disclosed technology 631, 632, 633), which then enables subsequent communication (641, 642, 643) from the BS to the UEs. The UE may be, for example, a smartphone, a tablet, a mobile computer, a machine to machine (M2M) device, an Internet of Things (IoT) device, and so on.

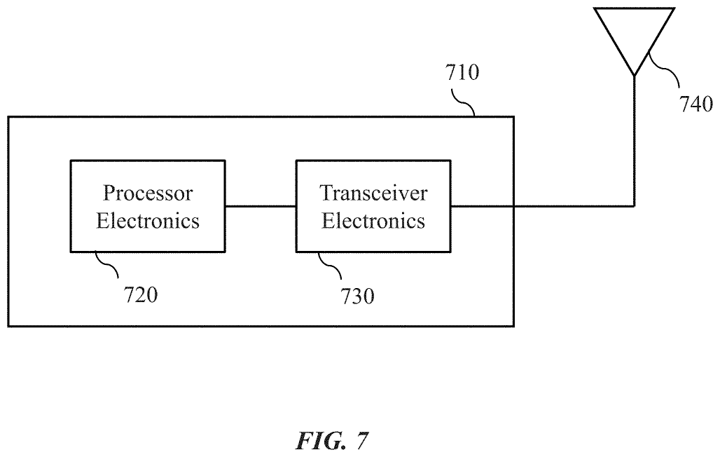

FIG. 7 shows an example of a block diagram representation of a portion of an apparatus. An apparatus 710 such as a base station or a user device which may be any wireless device (or UE) can include processor electronics 720 such as a microprocessor that implements one or more of the techniques presented in this document. The apparatus 710 can include transceiver electronics 730 to send and/or receive wireless signals over one or more communication interfaces such as antenna 740. The apparatus 710 can include other communication interfaces for transmitting and receiving data. The apparatus 710 can include one or more memories (not explicitly shown) configured to store information such as data and/or instructions. In some implementations, the processor electronics 720 can include at least a portion of transceiver electronics 730. In some embodiments, at least some of the disclosed techniques, modules or functions are implemented using the apparatus 710.

Additional features of the above-described methods/techniques that may be preferably implemented in some implementations are described below using a clause-based description format.

1. A method of wireless communication, comprising: receiving, by a first communication node from a second communication node, a first message that includes multicast broadcast service (MBS) information related to one or more multicast broadcast service (MBS) sessions; and sending, by the first communication node, to the second communication node, a second message that includes information for the one or more MBS sessions.

2. The method of clause 1, wherein the first message includes at least one of an identification (ID) of the MBS session, temporary mobile group identity (TMGI), a MBS service ID, MBS session aggregate maximum bit rate (AMBR), a mode of a point-to-point (PTP) or point-to-multipoint (PTM) scheme used for a user device at the second communication node, types of the one or more MBS sessions, MBS quality of service (QoS) flows information, or one or more multicast IP addresses.

3. The method of clause 1, further comprising, sending an NG application protocol message to a core network that includes assistance information related to a user device.

4. The method of clause 3, wherein the assistance information includes a tunnel mode used at the second communication node and/or a tunnel mode preferred at the first communication node.

5. The method of clause 3 further comprising: receiving, from the core network, an indication indicating a tunnel mode used for the user device.

6. The method of clause 1, wherein the information includes admitted MBS QoS flows information.

7. The method of clause 1, wherein the second message further includes a container to be sent to a user device, the container including MBS bearer configuration information.

8. The method of clause 1, wherein for the first communication node and the second communication node consisting of a centralized unit (CU) including a CU user plane (CU-UP) and a CU control plane (CU-CP) and a distribution unit (DU), the CU-CP is configured to send an RUC mode associated with a corresponding tunnel information to the CU-UP and/or the DU.

9. The method of clause 8, wherein the corresponding tunnel information is associated with a tunnel used for a downlink MBS traffic initial transmission or a downlink MBS traffic retransmission.

10. A method of wireless communication, comprising: sending, by the first communication node to a second communication node, a first message that includes multicast broadcast service (MBS) information related to one or more multicast broadcast service (MBS) sessions; and receiving, by the first communication node, from the second communication node, a second message that includes information for the one or more MBS sessions.

11. The method of clause 10, further comprising: sending the first messages to candidates communication nodes; and selecting one of the candidates communication nodes as the second communication node.

12. The method of clause 10, wherein the first message includes at least one of an identification (ID) of the MBS sessions, temporary mobile group identity (TMGI), a MBS service ID, MBS session aggregate maximum bit rate (AMBR), types of the one or more MBS sessions, a mode of a point-to-point (PTP) or point-to-multipoint (PTM) scheme used for a user device at the second communication node, MBS quality of service (QoS) flows information, or one or more multicast IP addresses.

13. The method of clause 10, wherein the second message includes admitted MBS QoS flows information.

14. The method of clause 10, further comprising: sending, to a core network, an NG application protocol message that includes an identifier of a user device.

15. The method of clause 14, wherein the NG application protocol message further includes at least one of an identifier of the second communication node, a mode switch indication, an individual tunnel set up request indication.

16. The method of clause 10, wherein for the first communication node and the second communication node consisting of a centralized unit (CU) including a CU user plane (CU-UP) and a CU control plane (CU-CP) and a distribution unit (DU), the CU-UP is configured to send an RLC; mode associated with a corresponding tunnel information to the CU-CP and/or the DU.

17. The method of clause 16, wherein the corresponding tunnel information is associated with a tunnel used for a downlink MBS traffic initial transmission or a downlink MBS traffic retransmission.

18. The method of any of clauses 1 to 17, wherein the first message and the second message conform to an application protocol format for an inter-node communication in a wireless network.

19. A communication apparatus comprising a processor configured to implement a method recited in any one or more of clauses 1 to 18.

20. A computer readable medium having code stored thereon, the code, when executed, causing a processor to implement a method recited in any one or more of clauses 1 to 18.

In some embodiments, a base station may be configured to implement some or all of the base station side techniques described in the present document.

It is intended that the specification, together with the drawings, be considered exemplary only, where exemplary means an example and, unless otherwise stated, does not imply an ideal or a preferred embodiment. As used herein, the use of “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication performed by a first communication node, comprising:
receiving, from a second communication node, a first message that includes multicast broadcast service (MBS) information related to one or more multicast broadcast service (MBS) sessions; and
sending, to the second communication node, a second message that includes information for the one or more MBS sessions.

2. The method of claim 1, wherein the first message includes at least one of an identification (ID) of the MBS session, temporary mobile group identity (TMGI), a MBS service ID, MBS session aggregate maximum bit rate (AMBR), a mode of a point-to-point (PTP) or point-to-multipoint (PTM) scheme used for a user device at the second communication node, types of the one or more MBS sessions, MBS quality of service (QoS) flows information, or one or more multicast IP addresses.

3. The method of claim 1, further comprising, sending an NG application protocol message to a core network that includes assistance information related to a user device.

4. The method of claim 3, wherein the assistance information includes a tunnel mode used at the second communication node and/or a tunnel mode preferred at the first communication node.

5. The method of claim 3, further comprising: receiving, from the core network, an indication indicating a tunnel mode used for the user device.

6. The method of claim 1, wherein the information includes admitted MBS QoS flows information.

7. The method of claim 1, wherein the second message further includes a container to be sent to a user device, the container including MBS bearer configuration information.

8. The method of claim 1, wherein for the first communication node and the second communication node consisting of a centralized unit (CU) including a CU user plane (CU-UP) and a CU control plane (CU-CP) and a distribution unit (DU), the CU-CP is configured to send an RLC mode associated with a corresponding tunnel information to the CU-UP and/or the DU.

9. The method of claim 8, wherein the corresponding tunnel information is associated with a tunnel used for a downlink MBS traffic initial transmission or a downlink MBS traffic retransmission.

10. A method of wireless communication performed by a first communication node, comprising:
sending, to a second communication node, a first message that includes multicast broadcast service (MBS) information related to one or more multicast broadcast service (MBS) sessions; and
receiving, from the second communication node, a second message that includes information for the one or more MBS sessions.

11. The method of claim 10, wherein:
the first message includes at least one of an identification (ID) of the MBS sessions, temporary mobile group identity (TMGI), a MBS service ID, MBS session aggregate maximum bit rate (AMBR), types of the one or more MBS sessions, a mode of a point-to-point (PTP) or point-to-multipoint (PTM) scheme used for a user device at the second communication node, MBS quality of service (QoS) flows information, or one or more multicast IP addresses; and
the method further comprises:
sending the first messages to candidates communication nodes; and
selecting one of the candidates communication nodes as the second communication node.

12-13. (canceled)

14. The method of claim 10, further comprising:
sending, to a core network, an NG application protocol message that includes an identifier of a user device.

15. The method of claim 14, wherein the NG application protocol message further includes at least one of an identifier of the second communication node, a mode switch indication, an individual tunnel set up request indication.

16-20. (canceled)

21. A first communication node comprising a memory for storing computer instructions and a processor in communication with the memory, wherein, when the processor executes the computer instructions, the processor is configured to cause the first communication node to:
receive, from a second communication node, a first message that includes multicast broadcast service (MBS) information related to one or more multicast broadcast service (MBS) sessions; and
send, to the second communication node, a second message that includes information for the one or more MBS sessions.

22. The first communication node of claim 21, wherein the first message includes at least one of an identification (ID) of the MBS session, temporary mobile group identity (TMGI), a MBS service ID, MBS session aggregate maximum bit rate (AMBR), a mode of a point-to-point (PTP) or point-to-multipoint (PTM) scheme used for a user device at the second communication node, types of the one or more MBS sessions, MBS quality of service (QoS) flows information, or one or more multicast IP addresses.

23. The first communication node of claim 21, wherein, when the processor executes the computer instructions, the processor is configured to further cause the first communication node to:
sending an NG application protocol message to a core network that includes assistance information related to a user device; and
receive, from the core network, an indication indicating a tunnel mode used for the user device.

24. The first communication node of claim 21, wherein the second message further includes a container to be sent to a user device, the container including MBS bearer configuration information.

25. A communication apparatus comprising a processor configured to implement a method recited in claim 10.

26. A computer readable medium having code stored thereon, the code, when executed, causing a processor to implement a method recited in in claim 1.

27. A computer readable medium having code stored thereon, the code, when executed, causing a processor to implement a method recited in in claim 10.
